(19) United States
(12) Patent Application Publication
(10) Pub. No.: US 2003/0074299 A1
(43) Pub. Date: Apr. 17, 2003

(54) Method for reprocessing accumulator or battery packs

(76) Inventor: Frank Saier, Sonnenbuhl (DE)

Correspondence Address: Robert H. Bachman, BACHMAN & LaPOINTE, P.C., Suite 1201, 900 Chapel Street, New Haven, CT, 06510-2802, US

(21) Appl. No.: 09/981,582

(22) Filed: Oct. 17, 2001

(51) Int. Cl. H02J 7/00; G06F 17/60

(52) U.S. Cl. 705/37; 320/109

(57) ABSTRACT

Method for reprocessing of rechargeable accumulator or battery packs including testing, replacing, tuning, providing individual special types and charging accumulators in a store or in the framework of an independent service by using a special service station. The method includes the provision of service station business partners, the provision of the central office for controlling the overall business procedures, and the provision of a product database. The central office controls the production of the service stations and the supply of the accumulators, batteries, or cells. In addition, the central office also controls the financing of the service stations for the service station business partners. The method includes a complete system for reprocessing accumulator or battery packs.

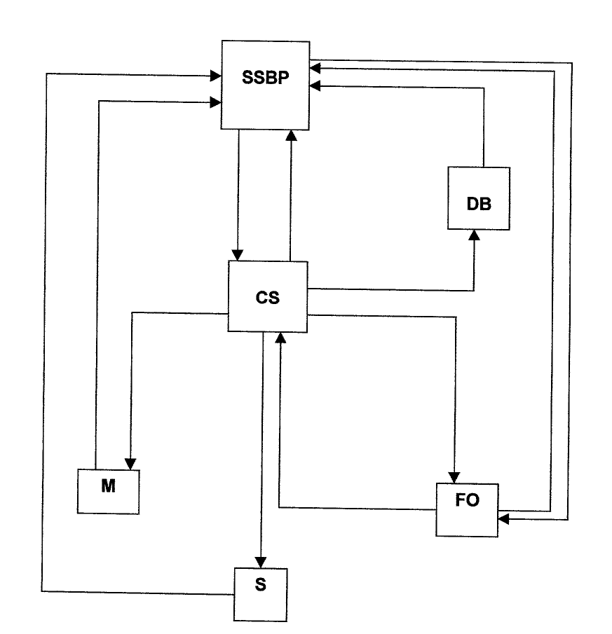

### DESCRIPTION

1. Field of the Invention

The invention relates to the reprocessing of accumulators or battery packs. It particularly relates to the performance and handling of the service as such, together with the business procedures connected with this.

2. Background of the Invention

Accumulators and batteries make the people of today ever more mobile. Telephoning on the road, working on the train or airplane on a laptop, but also screwing and drilling when no wall outlet is nearby. These are all taken for granted in our everyday life. Ever more devices are independent from a fixed power supply system and from cumbersome cables and get their energy from small, compact stores. Batteries must be replaced, accumulators must be recharged and serviced, and possibly replaced. There are just as many accumulators and batteries on the market as there are devices, but it is not always easy to obtain the appropriate energy store. Long trips and waiting times are annoying and, particularly with older devices which are no longer produced, it becomes difficult. In this case, under some circumstances, a relatively large amount money has to be paid for a new accumulator pack or battery pack after a short time. Many manufacturers cannot provide a replacement at all after a short time, so that the device can no longer be used.

Therefore, there is a need to renew run-down accumulators or batteries in an existing accumulator pack. In addition, individual and special types of accumulator or battery packs may be in demand according to the desires of the consumer.

The present invention therefore has as its object the offering of a corresponding service which allows the reprocessing of any desired type of accumulator or battery pack. This is achieved by the invention described in the following.

### BRIEF DESCRIPTIONS OF THE INVENTION

According to the invention, a method for reprocessing rechargeable accumulator or battery packs, including checking, replacing, tuning, providing individual special types and charging accumulators in a store in the framework of an independent service by using a special service station is described. The special service station is known and essentially comprises a special welding device for connecting the accumulators and/or batteries.

According to the method, multiple service station business partners, who are able to offer these services after establishment, are provided. These services can be performed in a shop or as an independent service provider, for example in the framework of a service technician service for the maintenance of technical facilities, for example in a hospital. Furthermore, a central office is provided for supplying the service station business partners with the necessary equipment and for controlling the service process for the service station business partners; a product database is provided with all data about accumulator or battery driven devices, including the manufacturer, technical data, the types of accumulator and/or battery packs or individual cells used and their technical data and prices, with the product database being supplied by the central office with appropriate data. The central office receives these data from the service station business partners, among other sources. Furthermore, the service station business partners receive access to the product database. The central office controls the production of the service stations, which are needed by new service station business partners, and the supply of accumulators or batteries at the request of the service station business partners through the central office. This method thus allows an optimum supply of the market with the parts necessary for repair through the service station business partners.

According to a further implementation, financing can also occur in such a way that a finance office for financing of service stations, which are purchased by the service station business partners from the central office, is provided, with the central office supplying the finance office with the necessary data concerning the service station business partners.

According to a further advantageous implementation of the method, it includes controlling the reprocessing of service stations which are given back to the finance office by service station business partners who give up their business. Through this measure, it is not always necessary to obtain new devices, rather devices taken back from the market can be overhauled and put in a like-new condition and supplied.

### BRIEF DESCRIPTION OF THE DRAWING

The present invention will be described in the following with reference to a schematic block diagram.

### EXACT DESCRIPTION OF THE INVENTION

The central office CS controls all business procedures and allocates the service station business partners SSBP the right to use the trademarks under which the services are to be offered to the customers by the service station business partners SSBP. The service station business partners SSBP purchase the devices and facilities necessary for performing services at the central office CS, particularly the welding device for connecting the individual cells. By order of the service station business partners SSBP, the central office CS arranges for the production of the welding station necessary for performing the services and the other facilities as well as their supply to the service station business partners SSBP. This is illustrated in the FIGURE in such a way that the producer M supplies directly; however, supply can also occur via the central office CS. The same is true in regard to the necessary accumulators or batteries. These are also ordered by the service station business partners at the central office CS, which in turn effects the supply of the desired parts via a supplier S, so that the desired parts arrive at the service station business partners SSBP within 24 hours.

A database DB is provided by the central CS which contains all of the information about the data of battery-operated devices and their producers, the technical data, the types of accumulators and and/or battery packs or individual cells used, and their technical data and prices. The service station business partners have access to this. The database DB is kept current by the central office CS, with the service station business partners also being required to inform the central office CS of newly appearing devices and/or the accumulators or batteries required for them, in order that this new information can enter the database DB.

The system thus allows the reprocessing of rundown accumulator and battery packs by specialists who are easy to train and who do not require any separate previous professional qualifications. The accumulators and batteries can be relatively rapidly checked and made ready for use again. The production of individual special accumulator packs or the increase of the accumulator capacity is thus also not a problem.

If the service station business partner is not in a position to procure the financial means for the purchase of the facility, there is the possibility that he can receive the necessary financial means through a finance office FO, which receives the data for this transaction from the central office CS. If a service station business partner, who has received the financial means via the finance office FO, no longer wishes to offer the service and wants to give back the welding device and the facility, the finance office FO notifies the central office of this, which causes the welding device and the facility to be taken back and processed, so that a new facility can be produced from the device and the facility which were given back.

This entire business idea thus provides a system with which the customers can be optimally supplied with reprocessed accumulator packs or battery packs.

1. Method for reprocessing chargeable accumulators or battery packs including the services of checking, replacing, tuning, providing individual special kinds and charging accumulators in a store or in the framework of an independent service by using a special service-station, said method comprising
providing of a multiple of service station business partners, said partners being able after establishment to offer said services;
providing a central service office for supplying said service station business partner with the necessary equipment, wherein said central service office controls the service process of said service station business partners;
providing a product database comprising all the data about battery power devices, including producer, technical data, kinds of accumulators or battery packs or single cells, and technical data, and prices, said product data base is supplied with the respective data by the central service office and said data at least in part being received from the service station business partners; and
providing access of said service station business partners to said product database;
wherein said central service office controls the manufacture of the service stations required for new service station business partners and delivery of accumulators or batteries on demand of the service station business partners.

2. Method according claim 1 further comprising
providing a financial office for financing the service station, being purchased by the service station business partner at the central service station; said financial office receiving the necessary data concerning the service station business partner from the central service station.

3. The method according claim 2 further comprising
controlling the processing of service stations that are given back to said financial office by service station business partners who do not want to continue with the store.
